(19) United States
(12) Patent Application Publication
(10) Pub. No.: US 2018/0053272 A1
(43) Pub. Date: Feb. 22, 2018

(54) INTELLECTUAL PROPERTY MANAGEMENT SYSTEM AND TOOL

(71) Applicants: Gouri Ashok GARGATE, Maharashtra (IN); INDIAN INSTITUTE OF TECHNOLOGY BOMBAY, Mumbai (IN)

(72) Inventor: Gouri Ashok Gargate, Maharashtra (IN)

(21) Appl. No.: 15/558,570

(22) PCT Filed: Mar. 28, 2016
(86) PCT No.: PCT/IN2016/000080

§ 371 Date: Oct. 6, 2016

(30) Foreign Application Priority Data
Mar. 28, 2015 (IN) 1118/MUM/2015

(51) Int. Cl. G06Q 50/18; G06Q 10/06; G06Q 10/10

(52) U.S. Cl. CPC G06Q 50/184; G06Q 10/10; G06Q 10/0639

(57) ABSTRACT

This invention relates to key issues of Intellectual Property Management (IPM) 5 efficiency enhancement and proposes a system (100) comprising server (103), database (104), input device (101), calculation unit (106) and access portal (105) which includes Intellectual Property Management (IPM) audit tool to measure IPM performance and its management. The present invention proposes an automated process to calculate Intellectual Property Management Performance Index (IPMPI) and provides Intellectual 10 Property Management maturity model to generate a report/analytics (108) for Intellectual Property Management (IPM) from Intellectual Property information stored in the system.

### TECHNICAL FIELD OF THE INVENTION

The present invention, in general, relates to the field of Intellectual Property Management (IPM) efficiency enhancement. More particularly, the invention relates to a system to measure of Intellectual Property Management performance of an organization by estimating Intellectual Property Management (IPM) maturity level.

### BACKGROUND AND THE PRIOR ART

With the development of science and technology, world has witnessed a shift in economy from farming to industry to knowledge. To protect this knowledge, Intellectual property (IP) regimes are evolved. It is not just Intellectual Property generation that helps in growth and development but its efficient management determines its role for wealth creation and well being of the society.

There is a need to assist micro, small and medium enterprises (MSMEs), research institutes, higher educational institutes and industrial organizations especially from developing countries to manage IP, in detail, to manage complete IP life cycle from designing IP policy, mining of potential IP to protect IP and commercialize the same (technology transfer). This is also needed for research institutes, higher educational institutes and industrial organizations from developed countries as the current available products for management of intellectual property are limited and are priced exorbitantly.

The observation is that there is a huge gap in IP generation and IP commercialization. How this gap can be reduced is the key query that needs to be addressed. Hence, there is a need to check IP Management (IPM) process efficiency of an organization. First step to check efficiency of IPM is IPM audit.

The literature on intangible assets (IA), IP, IPM and IPM audit is thoroughly analyzed to understand the current IPM and IPM audit practices followed by an organization. IPM audit practices and their objective change as per industry, national or organizational level but basic objective of IPM audit is an effective utilization of IP resources.

Jain et. al. (2009)proposed that IPMS do not work in silo and is controlled by technology development processes, strategic management processes and innovation management processes. It is also endorsed by Narvekar and Jain (2006) that one of the parameters to assess innovation management efficiency is output in the form of IP. These two studies on innovation and IP relationship clearly reflect the integrative nature of innovation and IP management.

A holistic audit of managing IP by Steffens and Waterhouse (2000) had given a framework to facilitate IPM audit in government agencies and a large public sector agriculture R & D agency. The framework suggests four overlapping domains as IP generation, IP rights, IP uptake and corporate support. Smandek B. et al (2010) had suggested balanced score card implementation for IP rights management in a public research institution. Sanchez et al (2006) followed case study approach and were more focused on intellectual capital (IC) management than IP and had provided a primary framework, the IC report in University (ICU) framework, for the management, measurement and disclosure of IC within universities and research centers. Punnose and Shobhana (2012) had shared IPM audit significance, experience and particulars regarding IPM audit of universities, production houses and public sector undertakings.

Bader et al (2008) had provided success factors for managing IP in the financial services. “Strategic IP portfolio management: technology appraisal” using technology heat map by Miyake et al (2004), follows patent analytics approach for managing IP in the financial services. Liu and Chin (2009) had proposed an IPM excellence audit system that breaks down the complicated IPM practices into a list of enabling criteria and the IPM performance criteria. Rastogi (2010) had captured codified IA. He discussed IPM audit process in general. Thomson Reuter's white paper by Cullen (2010) suggests three phases of IPM audit as IP management, benchmarking, and opportunity identification.

United States patent U.S. Pat. No. 8,041,696 B2 titled “idea tracking and management” discloses method and system for displaying and tracking ideas. U.S. Pat. No. 8,160,947 titled, “methods and systems for identifying and tracking potential property rights in software products”, discloses a method for identifying and tracking IP in software which will be helpful for auditing.

Thus, the analysis of literature on IPM audit suggests three major approaches followed by researchers as inventory, case study and IP analytics. Literature review suggests that there is a need to conduct in-depth study of the IPM audit process to develop the Intellectual Property Management system (IPMS) which can help organizations for self assessment of IPM performance. The need is very crucial especially for organizations from developing world.

Literature review also clearly reflects that the IPM audit area is not much explored to develop matrices and measurement tools to compute IP score of an organization, tools to manage IP at micro level, to measure IPM performance level of an organization which can help in classification and benchmarking of organizations based on IPM performance. Therefore there was a need of IPMS development tool and the present study addresses this issue.

The present invention helps to generate integrated IP Portfolio which can act as a bargaining chip for the organization for wealth creation and includes potential IP, non-commercialized IP, commercialized IP and acquired IP.

### OBJECT OF THE INVENTION

The prime object of the present invention is to overcome one or more of the drawbacks of the related prior art.

It is an object of the present invention to provide Intellectual Property Management System to estimate Intellectual Property Management (IPM) maturity level of an organization.

Another object of the present invention is to provide holistic view of Intellectual Property Management System (IPMS) to manage Intellectual Property.

Yet another object of the present invention is to provide Intellectual Property Management (IPM) audit tool to construct the ‘IPM maturity model’ of an organization.

It is an object of the present invention to provide computation method of ‘IPM performance index’ (IPMPI) using IPM audit tool.

It is an object of the present invention to provide automatic analysis of IP information of an organization using the auto-generated instructions and parameters.

It is a further objective of the present invention to provide a network-based Intellectual Property Management System (IPMS).

It is an object of the present invention to provide self assessment tool to help technology managers to evaluate IPM without taking help from an IP expert.

It is yet further object of the present invention to provide guidelines to maintain IP inventories from different perspectives.

It is another object of the present invention is to provide data analytics, reports and insight of IP management of an organization.

It is a further object of the present invention is to provide indicators for IPM process related decisions and to develop various matrices to check the performance efficiency of current IPM of an organization.

These and other objects of the present invention will become readily apparent from the following detailed description read in conjunction with the accompanying drawings.

### SUMMARY OF INVENTION

The following presents a simplified summary of the invention in order to provide a basic understanding of some aspects of the invention.

According to one of the non-limiting aspect of the present invention, there is provided a network-based system to estimate Intellectual Property Management (IPM) maturity level of an organization and generate a report/analytics for Intellectual Property Management (IPM), comprising:

at least one server connected to the communications network and comprising a processor;
at least one centralized database connected to the communications network to store the intellectual property information;
at least one user input device comprising a processor to access the server in a limited manner over the communications network to update the intellectual property related information associated with organization to store in the centralized database;
at least one access portal for Intellectual property management; and at least one calculation unit estimating the Intellectual Property Management Performance Index (IPMPI);
wherein the access portal comprising Intellectual Property Management audit tool classifies the intellectual property related information associated with organization, stored in the centralized database via the server;
wherein the classification of an organizations is based on ‘plurality of predefined stage parameters comprising plurality of predefined key Intellectual Property Management (IPM) process parameter(s) defining Intellectual Property (IP) management audit model; and
wherein each said predefined key Intellectual Property Management (IPM) process parameter comprises plurality of predefined level parameters to input into said calculation unit to project the performance level of the organization based on said predefined key Intellectual Property Management (IPM) process parameters and the Intellectual Property Management Performance Index (IPMPI).

In an another non-limiting aspect of the present invention, there is provided a system to estimate Intellectual Property Management (IPM) maturity level of an organization and generate a report/analytics for Intellectual Property Management (IPM), comprising:

at least one memory unit to store the intellectual property related information;
at least one user interface with a processor; and
at least one calculation unit estimating the Intellectual Property Management Performance Index (IPMPI);
wherein the access portal comprising Intellectual Property Management audit tool classifies the intellectual property information associated with organization, stored in the centralized database via the server;
wherein the classification is based on plurality of predefined stage parameters comprising plurality of predefined key Intellectual Property Management (IPM) process parameter(s) defining Intellectual Property (IP) management audit model; and
wherein each said predefined key Intellectual Property Management (IPM) process parameter comprises plurality of predefined levels to input into said calculation unit to project the performance level of the organization based on said predefined key Intellectual Property Management (IPM) process parameters and the Intellectual Property Management Performance Index (IPMPI).

In another aspect of the present invention there is provided with three level ‘IPM audit model’. The ‘IPM audit model’ has 5 stages as pre-IP stage, IP stage, post IP stage, IP acquisition and IP enforcement and 15 major processes. The model helps in two ways: (i) it helps to focus on particular IPM process and (ii) it helps to take holistic view of IPMS to manage IP. ‘IPM audit model’ is further explored to develop ‘IPM audit tool’. IPM audit tool is a self assessment tool. Each of 15 major processes suggested in ‘IPM audit model’ are explored in detail to develop five levels of performances for each major process. The invention further proposes computation of ‘IPM performance index’ (IPMPI) using ‘IPM audit tool’.

To enable the invention to be more clearly understood and carried into practice, reference is now made to the accompanying drawing in which like references denote like parts throughout the description.

### BRIEF DESCRIPTION OF THE ACCOMPANYING DRAWINGS

The different preferred embodiments of the invention will now be described, by way of example with reference to the accompanying drawings, in which:

FIG. 1 represents the block diagram of network-based system of the present invention.

FIG. 2 shows the block diagram of arrangement of network-based system in plurality of server system of the present invention.

FIG. 3 depicts the flow-chart implementing method steps in network-based Intellectual Property Management System (IPMS) of the present invention.

FIG. 4 illustrates IPM audit model to compute Intellectual Property Management Performance Index (IPMPI).

FIG. 5 shows IPM maturity model used to classify the performance of the organizations.

FIG. 6 illustrates mapping of organization maturity level on the IPMS design matrix.

FIG. 7 illustrates user interface screen I of Intellectual Property Management System.

FIG. 8 shows user interface screen II of Intellectual Property Management System.

FIG. 9 shows user interface screen III of Intellectual Property Management System.

Persons skilled in the art will appreciate that elements in the figures are illustrated for simplicity and clarity and may have not been drawn to scale. For example, the dimensions of some of the elements in the figure may be exaggerated relative to other elements to help to improve understanding of various exemplary embodiments of the present disclosure.

Throughout the drawings, it should be noted that like reference numbers are used to depict the same or similar elements, features, and structures.

### DETAILED DESCRIPTION OF THE INVENTION

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions, symbols, abbreviation and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic is intended to provide.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

The advantages, nature, and various additional features of the invention will appear more fully upon consideration of the illustrative experiment now to be described in detail in connection with accompanying drawings.

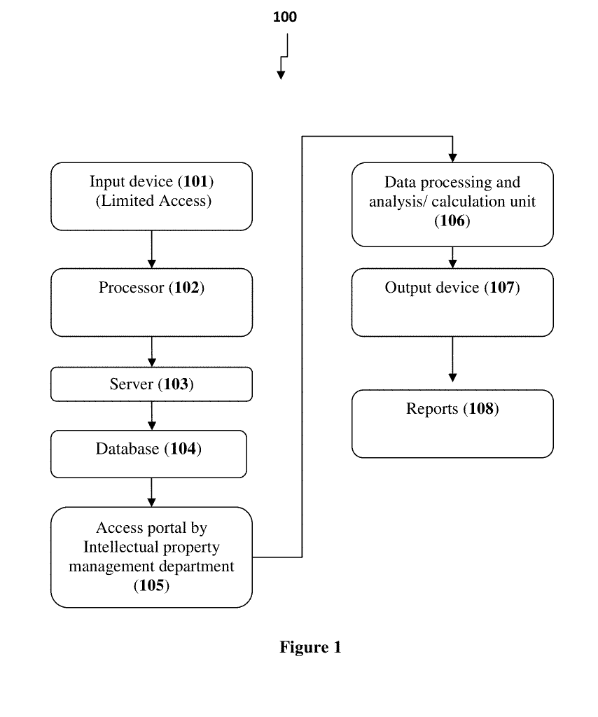

According to one of the embodiment of the present invention, the present invention provides a network-based system (100) as shown in FIG. 1. The user input device (101) comprising a processor (102) having a limited accesses, communicates via server (103) over the communications network to update the intellectual property related information associated with organization to store in the centralized database (104). The centralized database (104) stores the intellectual property related information of the organization. The System (100) comprises access portal (105) with an audit tool and a calculation unit (106) estimating the Intellectual Property Management Performance Index (IPMPI) and generate an Intellectual property management report/analytics (108) via output device (107).

The network in the present invention may take any wired/wireless form of known connective technology (e.g., corporate or individual LAN, enterprise WAN, intranet, Internet, Virtual Private Network (VPN), combinations of network systems, etc.) to allow network server (103) provide local/remote information and control data to/from other locations (e.g., other remote database servers, remote databases, network servers/user interfaces, etc.

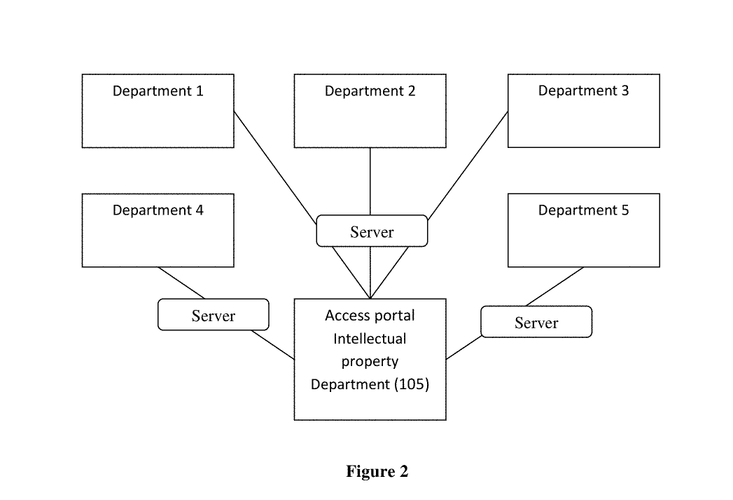

According to another embodiment of the present invention, the network-based Intellectual Property Management System (IPMS) (100) provides estimates for Intellectual Property information for the plurality of Intellectual Property (IP) departments (can be of different technical field) communicating with individual or same server, accessible by access portal (105), as shown in FIG. 2. In accordance with an aspect of the present invention, network server (103) may be serving one or more users over a collection of remote and disparate networks (e.g., Internet, intranet, VPN, etc.).

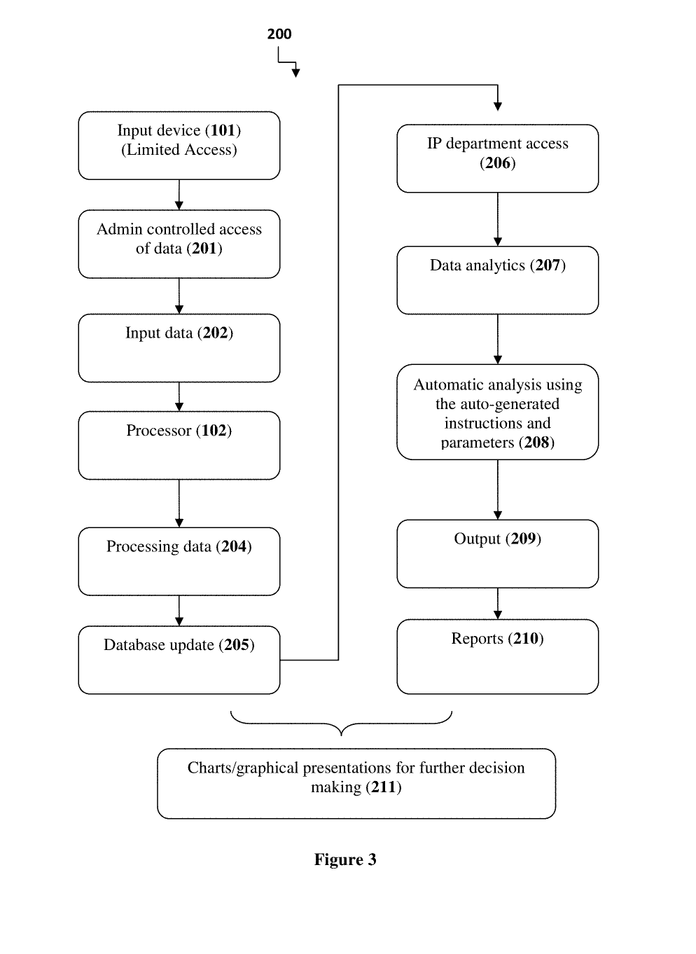

FIG. 3 shows the flow-chart (200) implementing method steps in system of the present invention providing automatic analysis of IP information of an organization using the auto-generated instructions and parameters (208). In an exemplary embodiment of the present invention the access hierarchy allows the user to set the default limits of access to particular IP information. The user inputs data via the administrator controlled access of data (step 201) and then the input data is processed (step 202 & 204) by the processor (102) to update the database (step 205). In the next step the data can be accessed by the required IP department (206) for data analytics (207) individually or automatic analysis using the auto-generated instructions and parameters (208) to get required output (209) or reports (210) by way of Charts/graphical presentations for further decision making (211).

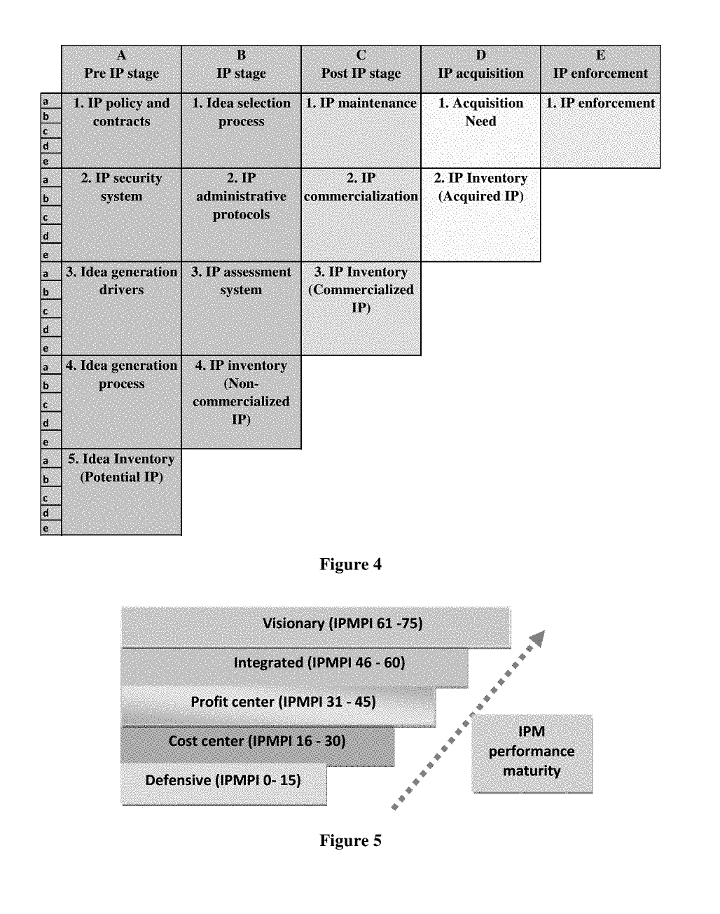

In accordance with the one of the preferred embodiment of the present invention, Intellectual Property Management System (IPMS) provides Intellectual Property management audit model comprising 5 stages as pre-IP stage, IP stage, post IP stage, IP acquisition and IP enforcement and 15 IPM processes as depicted in FIG. 4. The model helps in two ways first, it helps to focus on particular IPM process and second, it helps to take holistic view of IPMS to manage IP. Intellectual Property management audit model is further explored to develop IPM audit tool where the IPM audit tool is a self assessment tool. Each of 15 major IPM processes suggested in the IPM audit model of the present invention are explored in detail to develop five levels of performances for each major process. The fifteen major IPM processes identified include 4 types of inventories. The 15 IPM processes are organized systematically into 5 stages in such a way that each stage from 1 to 4 generates inventory. All the fifteen processes are further classified into five levels of performances to develop Intellectual Property Management System (IPMS).

The determination of different stages with 15 IPM processes comprising 5 levels (a, b, c, d, e) of the Intellectual Property (IP) management audit model is based on the following guidelines found by the present inventors as shown in Table I:

TABLE I
1. Pre IP stage: IP Generation: 5 major processes

| | | |
|---|---|---|
| 1.1. IP policy and | a | Strong alignment of IP policy with corporate strategy, dynamic IP policy |
| contracts | | changing in response to market and competitiveness, properly maintained |
| | | contract and agreements (electronic/traditional record system), periodic check |
| | | and improvement of agreements and contracts |
| | b | Dynamic IP policy changing in response to market and competitiveness, |
| | | properly maintained contract and agreements (electronic/traditional record |
| | | system), periodic check and improvement of agreements and contracts |
| | c | Defined IP Policy, indexing of contracts and agreements is practiced |
| | d | Emerging IP policy and emerging practices to index contracts and agreements |
| | e | No defined IP policy, no proper indexing of contracts and agreements |
| 1.2. IP security | a | Proactive identification and protection of potential IP generating data, |
| system | | systems, processes, limited access areas, restricted employees access areas, |
| | | use of locked file cabinets, limited data access, along with use of badges & |
| | | sign -in-out logs |
| | b | IP security of data is diligently followed, limited access areas, restricted |
| | | employees access areas, use of locked file cabinets, limited data access, along |
| | | with use of badges &sign -in-out logs |
| | c | IP security of data is diligently followed, use of locked file cabinets, limited |
| | | data access, along with use of badges & Sign -in-out logs |
| | d | Emerging IP security system along with use of badges &sign -in-out logs |
| | e | Very primitive IP security is maintained as use of badges & sign -in-out logs |
| 1.3. Idea generation | a | Global mapping of potential partners for open innovation, use of crowd |
| drivers | | sourcing, periodic special IP awareness training, idea generation motivation is |
| | | appraisal/incentive/appreciation driven/motivation by top management, |
| | | periodic idea generation activity/campaign |
| | b | Special IP awareness training, idea generation motivation is appraisal/ |
| | | incentive/appreciation driven/motivation by top management, periodic idea |
| | | generation activity/campaign |
| | c | Basic IP awareness training mandatory, idea generation motivation is |
| | | appraisal/incentive/appreciation driven/motivation by top management, |
| | | annual idea generation campaign |
| | d | Fundamental level IP awareness training is conducted, idea generation |
| | | motivation is appraisal/incentive/appreciation driven/motivation by top |
| | | management, no or very rare idea generation campaign |
| | e | If required IP awareness training, idea generation motivation is incentive |
| | | driven, no idea generation campaign |
| 1.4. Idea generation | a | Diligent IP and business analytics, proactive identification of potential IP |
| process | | generating projects through IP & technology landscapes, periodic competitive |
| | | intelligence reports generated in-house/outsourced, sufficient databases and |
| | | literature resources, efficient team interaction, efficient interdepartmental |
| | | interaction and knowledge sharing platforms, liaison role is defined and |
| | | proactive |
| | b | Diligent IP and business analytics, periodic competitive intelligence reports |
| | | generated in-house/outsourced, sufficient databases and literature resources, |
| | | efficient team interaction, efficient interdepartmental interaction and |
| | | knowledge sharing platforms, liaison role is defined |
| | c | IP and business analytics generally followed, sufficient databases and |
| | | literature resources, limited team interaction and knowledge sharing platforms, |
| | | no dedicated liaison, if required competitive intelligence reports generated in- |
| | | house/outsourced |
| | d | IP and business analytics developing stage, few databases and literature |
| | | resources available, limited team interaction and knowledge sharing platforms, |
| | | no dedicated liaison |
| | e | Primitive or no IP and business analytics, primitive or no competitive |
| | | intelligence reports, very few databases and literature resources, no or limited |
| | | team interaction and knowledge sharing platforms |
| 1.5. Idea Inventory | a | Easy accessibility of online idea sharing, easy accessibility of online IDF, no |
| (Potential IP) | | managerial control over idea sharing, IDF inventory (potential IP), idea |
| | | categorization and business mapping, preparation of idea inventory, idea |
| | | inventory may be revisited every six months |
| | b | Easy accessibility of online idea sharing, easy accessibility of online IDF, no |
| | | managerial control over idea sharing, emerging IDF inventory (potential IP) |
| | | system, emerging idea categorization and business mapping |
| | c | Easy accessibility of online idea sharing/traditional idea sharing system, easy |
| | | accessibility of online IDF |
| | d | Traditional idea sharing system, traditional IDF system |
| | e | No concept of idea inventory |

2. IP stage: IP Protection: 4 major processes

| | | |
|---|---|---|
| 2.1. Idea selection | a | Probable IP generation mapping before starting the project, defined financial |
| | | plan for IP protection, various defined filters for prioritizing ideas, defined |
| | | plan for market identification and product launch in view of IP, defined |
| | | provision for IP acquisition/open innovation if required for further |
| | | development of the project, interdepartmental or inter business unit idea |
| | | sharing for its development |
| | b | Probable IP generation mapping before starting the project, defined financial |
| | | plan for IP protection, Various defined filters for prioritizing ideas, defined |
| | | plan for market identification and product launch in view of IP is followed, |
| | | defined provision for IP acquisition/open innovation if required for the |
| | | development of project |
| | c | Probable IP generation before starting the project is followed, defined |
| | | financial plan for IP protection is followed, few defined filters for prioritizing |
| | | ideas are identified and followed, there may or may not be defined plan for |
| | | market identification and product launch in view of IP |
| | d | Probable IP generation before starting the project may or may not followed, |
| | | defined plan for IP protection may or may not followed, no defined plan for |
| | | market identification and product launch in view of IP |
| | e | Probable IP generation before starting the project is not followed, no defined |
| | | plan for IP protection, no defined plan for market identification and product |
| | | launch in view of IP |
| 2.2. IP | a | Proactive liaison role to pitch the IP related activates for early and fast IP |
| administrative | | development and protection, efficient data management tools, electronic |
| protocols | | laboratory notebook with admin control, standard protocol for laboratory |
| | | notebook maintenance, periodic improvement of laboratory notebook, |
| | | dedicated IP department, dedicated budget for IP protection, project tracking |
| | | for IP generation, defined procedures to identify IP, inter-business unit |
| | | transfer of IP considering business relevance |
| | b | Efficient data management tools, electronic laboratory notebook with admin |
| | | control/physical laboratory notebook, standard protocol for laboratory |
| | | notebook maintenance, dedicated IP department, dedicated budget for IP |
| | | protection, project tracking for IP generation, defined procedures to identify |
| | | IP, inter-business unit transfer of IP considering business relevance |
| | c | Enough data management tools, primitive electronic laboratory notebook with |
| | | admin control/physical laboratory notebook, few standard protocols for |
| | | laboratory notebook maintenance, IP department in developing stage, |
| | | dedicated budget for IP protection |
| | d | Primitive data management tools, primitive physical laboratory notebook, |
| | | standard protocol for laboratory notebook maintenance emerging, IP |
| | | department emerging stage, limited dedicated budget for IP protection |
| | e | No or primitive data management tools, no or primitive physical laboratory |
| | | notebook, no standard protocol for laboratory notebook maintenance, no |
| | | separate IP department, no dedicated budget for IP protection |
| 2.3. IP assessment | a | Detailed valuation of IP before IP filing, defined filters for prioritization of |
| system | | inventions for IP protection, novelty check and infringement analysis is |
| | | diligently followed, IP assessment team involves IP personnel, inventor, |
| | | technical person, representative from marketing department, and top |
| | | management, defined filters for keeping invention trade secret |
| | b | Defined filters for prioritization of inventions for IP protection, novelty check |
| | | and infringement analysis is diligently followed, IP assessment team involves |
| | | IP personnel, inventor, technical person, representative from marketing |
| | | department, and top management, defined filters for keeping invention trade |
| | | secret |
| | c | Novelty check and infringement analysis generally followed, IP assessment |
| | | team involves IP personnel, inventor, technical person, representative from |
| | | marketing department, top management in critical decision scenario, very few |
| | | defined filters may be set for keeping invention trade secret |
| | d | Novelty check and infringement analysis may or may not followed, IP |
| | | assessment team may or may not involve IP personnel, inventor, technical |
| | | person, representative from marketing department, top management, no |
| | | defined filters for keeping invention as trade secret |
| | e | No or primitive IP assessment system |
| 2.4. IP inventory | a | IP type wise, product/process wise IP, licensed/in-house developed/sale out |
| (Non- | | categorization/collaborative IP type inventory maintained, few more detailed |
| commercialized IP) | | inventories as core IP and related IP, defensive purpose/strategic purpose IP |
| | | inventory, useful life and business mapping of IP, based on capital/tax saving |
| | | approach IP inventory are maintained |
| | b | IP type wise, product/process wise IP, licensed/in-house developed/sale out |
| | | categorization/collaborative IP type inventory maintained, few more detailed |
| | | inventories as core IP and related IP, defensive purpose/strategic purpose IP |
| | | inventory are maintained, useful life and business mapping of IP may or may |
| | | not followed, based on capital/tax saving approach IP inventory may or may |
| | | not maintained |
| | c | IP type wise, product/process wise IP, licensed/in-house developed/sale out |
| | | categorization/collaborative IP type inventory maintained, few more detailed |
| | | inventories may or may not developed |
| | d | IP type wise, product/process wise IP inventory maintained, licensed/in-house |
| | | developed/sale out categorization may or may not maintained |
| | e | Very primitive or no IP inventory of non-commercialized IP |

3. Post IP stage: IP Commercialization: 3 major processes

| | | |
|---|---|---|
| 3.1. IP maintenance | a | Use IP valuation methods for IP maintenance decisions, IP maintenance |
| | | processes are established, periodic revisiting of IP inventory to take decision |
| | | related to maintenance or surrender, consulting with inventor and other related |
| | | individuals while taking the decision may or may not followed, IP inventory |
| | | considering the viability of invention/licensed/sold/in house |
| | | development/defensive strategy is developed to take the decision related to IP |
| | | maintenance |
| | b | IP maintenance processes are established, periodic visiting of IP inventory to |
| | | take decision related to maintenance or surrender, consulting with inventor |
| | | and other related individuals while taking the decision may or may not |
| | | followed, IP inventory considering the viability of invention/licensed/sold/in |
| | | house development/defensive strategy is developed to take the decision related |
| | | to IP maintenance |
| | c | IP Inventory and maintenance processes are in developing stage, IP inventory |
| | | may be revisited to decide maintain or surrender, consulting with inventor and |
| | | other related individuals while taking the decision may be followed |
| | d | IP maintenance processes are in primitive stage, few indicators for IP |
| | | maintenance are developed, consulting with inventor and other related |
| | | individuals while taking the decision may be followed |
| | e | Generally all IP maintained |
| 3.2. IP | a | IP commercialization is proactively followed, proactive identification of |
| commercialization | | buyer/licensee/collaboration is common practice, for IP commercialization |
| | | decision input from IP, law, business analysis department and top |
| | | management along with Marketing/customer/R & D department are |
| | | considered, regulatory protocols and due diligence analysis as FTO, |
| | | competitive intelligence, investment v/s performance analysis are common |
| | | practices |
| | b | IP commercialization is generally routine practice, for IP commercialization |
| | | decision input from IP, law, business analysis department and top |
| | | management along with marketing/customer/R & D department are |
| | | considered, regulatory protocols and due diligence analysis as FTO, |
| | | competitive intelligence are common practices |
| | c | IP commercialization is followed, for IP commercialization decision input |
| | | from marketing, R & D department and top management are generally |
| | | followed, regulatory protocols and due diligence analysis as FTO are |
| | | performed |
| | d | IP commercialization is emerging, if IP commercialization decision is the need |
| | | then input from marketing, R & D department and top management are |
| | | generally followed, regulatory protocols and due diligence analysis as |
| | | FTO(Freedom to operate) are performed |
| | e | IP commercialization is a rare activity |
| 3.3. IP Inventory | a | Proactive efforts to convert maximum IP into commercialized IP are followed, |
| (Commercialized | | detailed inventory about commercialized IP (licensed, in-house developed, |
| IP) | | cross functional transferred, strategically exploited etc.) is maintained and |
| | | updated periodically, integrated IPM(bundling of IP) approach is strongly |
| | | adopted |
| | b | Proactive efforts to convert maximum IP into commercialized IP are generally |
| | | followed, detailed inventory about commercialized IP (licensed, in-house |
| | | developed, cross functional transferred, strategically exploited etc.) is |
| | | maintained and updated periodically |
| | c | Detailed inventory of ‘commercialized IP’ (licensed, in-house developed, |
| | | cross functional transferred, strategically exploited etc.) is maintained |
| | d | Primitive IP inventory of ‘commercialized IP’ is maintained |
| | e | No special inventory is maintained as ‘commercialized IP’ inventory |

4. IP Acquisition: 2 major processes

| | | |
|---|---|---|
| 4.1. Acquisition | a | Acquisition activity is very proactive to identify ‘potential IP’developing |
| Need | | organizations (SMEs/competitors) to handle future threats of competitiveness, |
| | | defined acquisition strategy, due diligence activity for acquisition is well |
| | | defined |
| | b | Defined strategy for acquisition with dedicated processes to identify |
| | | acquisition opportunity, due diligence activity for acquisition is emerging |
| | c | Acquisition activity is emerging strongly |
| | d | Need based acquisition activity |
| | e | No acquisition activity |
| 4.2. IP Inventory | a | Proactive identification of potential IP need to be acquired along with properly |
| (Acquired IP) | | maintained detailed acquired IP inventory with details as important timelines, |
| | | terms and conditions, owner, critical clauses etc. especially if licensed in/ |
| | | patent pool/cross licensing is maintained |
| | b | Detail inventory of acquired IP as important timelines, terms and conditions, |
| | | owner, critical clauses etc. especially if licensed in/patent pool/cross licensing |
| | | is maintained |
| | c | Primitive acquired IP inventory maintained |
| | d | No or very negligent acquired IP |
| | e | No acquired IP |

5. IP Enforcement

| | | |
|---|---|---|
| 5.1. IP enforcement | a | Dedicated staff/outsourcing to keep watch on IP infringement if any, |
| | | dedicated staff/outsourcing to execute the IP right if there is any infringement |
| | b | In house staff/outsourcing service provider may check infringement of all or |
| | | few important IPs and enforcement action is taken. |
| | c | Infringement analysis and enforcement processes for few important IPs is |
| | | diligently followed |
| | d | Emerging practices to detect infringement and enforcement of few important |
| | | IPs |
| | e | No dedicated check system for IP infringement detection and enforcement |

The Intellectual Property Management System (IMPS) of the present invention groups the Intellectual Property related information of the organization into different stages based on the following criterions:

### Pre IP Stage:

Pre IP stage is the first stage and is focused on ‘IP generation’. This is a ‘value creation stage’ where ‘potential IP’ identification is a challenge. This challenging task can be handled if the five major processes suggested in the model are followed. This will lead to identification of ‘potential IP’. Also in this stage it is necessary to build the culture of data confidentiality in the organization. This is because, though IP valuation techniques are available, the real value of the ‘potential IP’ can be revealed only when it is commercialized, so each and every data is to be valued diligently. Thus the ‘pre IP stage’ with 5 major processes is expected to produce ‘idea inventory’.

### IP Stage

IP stage is the second stage and is focused on ‘IP protection’. This is the stage where IP is protected and is ready for commercial or strategic exploitation. Thus this is the IP which is still not commercially exploited so this is a ‘non-commercialized IP’ of an organization. In this stage, the challenging task is a selection of the ideas which are important strategically and commercially. This challenging task can be handled smoothly if some pointers are provided for this critical decision making process. Also for easy management of non-commercialized IP, this IP can be maintained in various inventory formats. Some suggestions are provided here for IP inventory preparation. This idea screening and protection related processes resulted into development of second stage of IPM that is the ‘IP stage’ with 4 major processes which is expected to produce IP inventory (non-commercialized IP).

### Post IP Stage

Post IP stage is the third stage and is focused on ‘IP commercialization’. This is the stage where IP is commercialized either to make financial gain or to gain strategic advantage. This is the IP which is used to gain its value, so this is a ‘commercialized IP’ of an organization. This stage is a ‘value extraction stage’. Here the challenging task is a selection of the IP for further maintenance. This identification of IP is a very important strategically and commercially. IPM audit model suggests some pointers for this critical decision making process. This resulted into the development of third stage of IPM that is the ‘post IP stage’ stage with three major processes which is expected to produce ‘IP inventory (commercialized IP)’.

### IP Acquisition

IP acquisition is the fourth stage and is more strategic intervention. This is the stage where IP is acquired either for financial gain or strategic advantage. Here the challenging task is the valuation of the IP to be acquired and forecasting the post acquisition consequences. Some pointers are provided here for this critical decision making process. This resulted into development of fourth stage of IPM that is the ‘IP acquisition’ stage with two major processes which is expected to produce ‘IP inventory (acquired IP)’.

### IP Enforcement:

IP enforcement is the fifth stage and is most challenging task especially in developing countries like India. This is the stage where IP enforcement related activities are monitored and implemented. Unless these are implemented there is no or minimum use of earlier developments of IPMS. This resulted into development of fifth stage of IPM that is ‘IP enforcement’ with 1 major process.

FIG. 4 provides a detailed understanding of the 15 major IPM processes followed by an organization. Next, the Intellectual Property Management System (IPMS) of the present invention assigns a level to each key IPM process (e.g. a, b, c, d, or e as per the ‘IPM audit tool’ guidelines) in an automated process. Once the assignment of the performance level has been completed, then by using the formula (equation 1) IPMPI for an organization can be computed. The IPMS computes ‘IPM performance index’ (IPMPI) using ‘IPM audit tool’. The proposed IPMPI computational formula is as follows:

A[1( . . . )+2( . . . )+3( . . . )+4( . . . )+5( . . . )]=p

B[1( . . . )+2( . . . )+3( . . . )+4( . . . )]=q

C[1( . . . )+2( . . . )+3( . . . )]=r

D[1( . . . )+2( . . . )]=s

E[1( . . . )]=t

So, IPM Performance Index (IPMPI)=p+q+r+s+t (1)

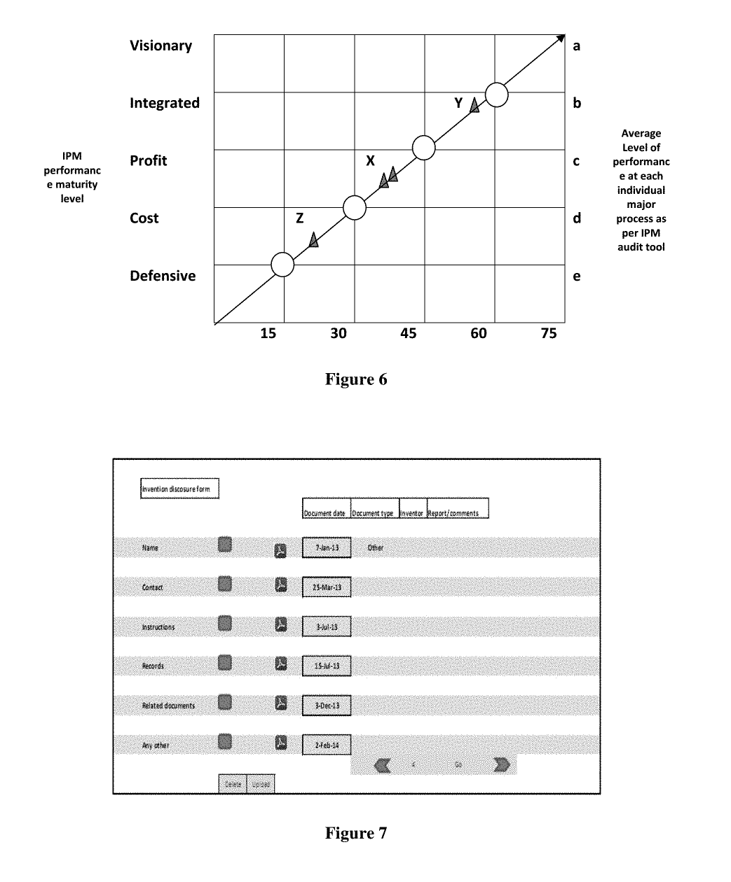

Here in equation (1) A, B, C, D and E represents different stages defined in Intellectual Property management audit model of the present invention comprising 5 stages as pre-IP stage (A), IP stage (B), post IP stage (C), IP acquisition (D) and IP enforcement (E), where the number 1, 2, 3, 4, 5 in different stages represents the different IPM processes and ( . . . ) represents the level (a, b, c, d and e) of the Intellectual Property information based on the guidelines defined in Table I. The present invention proposes a new way of classifying organizations defining an IPM maturity model. The organizations can be classified as defensive, cost center, profit center, integrative, and visionary as depicted in FIG. 5. Proposed IPM system (IPMS) comprising IPM audit tool of the present invention can help in assessing organization's IPM performance. IPM audit tool can provide guidelines to maintain IP inventories from different perspectives and also provides indicators for IPM process related decisions. ‘IPM maturity model’ helped to develop ‘IPMS design matrix’ as depicted in FIG. 6.

In accordance to another non-limiting embodiment of the present invention the IPM maturity model of the present invention assesses the maturity level of an organization's IPM performance using the IPMPI. The IPM audit tool is explored to compute an IPMPI as described above. It has been observed that the IPMPI can lie anywhere within a range of 0 to 75 units. The IPM maturity of an organization can be assessed using this ‘IPM maturity model’, which provides a standard scale to map IPM performance maturity using IPMPI. Insights derived through case study data analysis, literature analysis, informal data collection and analysis, interaction with legal experts and IP professionals, and the researcher's own practical experience were employed to develop the ‘IPM maturity model’ shown in FIG. 5.

Thus, if the IPMPI is in the range of 0 to 15, the organization is at the defensive level; if the IPMPI is in the range of 16 to 30, the organization is at the cost center level; if the IPMPI is in the range of 31 to 45, the organization is at the profit center level; if the IPMPI is in the range of 46 to 60, the organization is at the integrated level; and if the IPMPI is in the range of 61 to 75, the organization is at the visionary level.

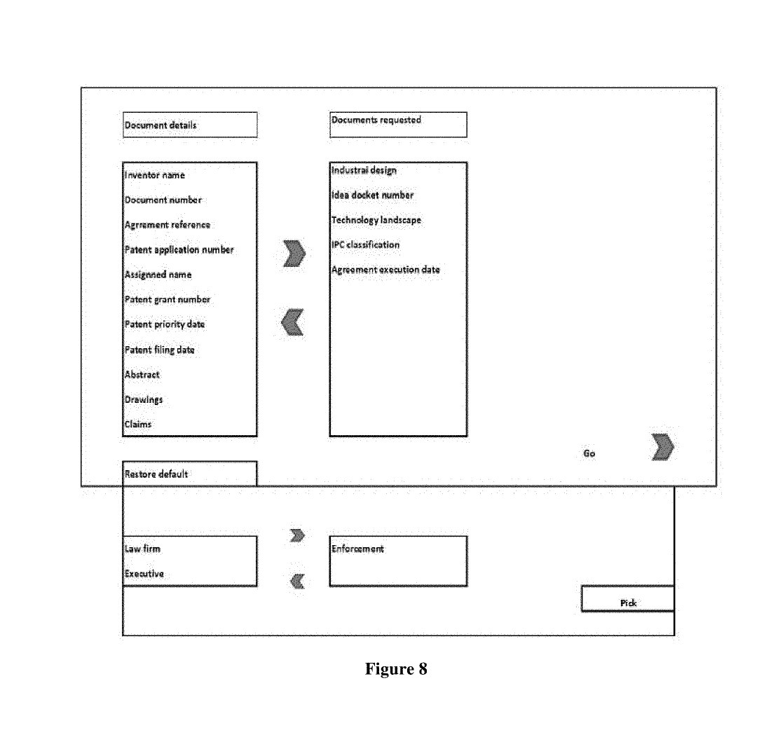

As such there will be generation of many different types of screens during whole process of IPM. FIG. 7, FIG. 8 and FIG. 9 are representation of these screens and the functionality of the present invention, interacting with the user to input and analyze Intellectual Property related information.

### Example and Case Study

The in-depth case studies using the IPMS of the present invention helped the present inventors to assign performance levels. Inventors of the present invention also cross checked the assignment of performance level by sharing the IPMS comprising the audit tool with IP personnel in the organization. Brief IPM audit reports of the organizations (X, Y, Z) are presented below:

### Organization ‘X’:

At the first or pre-IP stage, Organization ‘X’ is seen to follow two processes at performance level ‘c’ and three processes (idea generation, idea generation drivers, and idea inventory) at performance level ‘d’. Thus, according to IPM audit tool, their pre-IP stage scores 12 units out of 25. This suggests that Organization ‘X’ IP policy and IP security-related processes are at the mid-level and there is thus scope to improve their idea generation process, idea generation drivers, and hence the ‘idea inventory’. This improvement in these two major processes will help the organization to move from a level ‘d’ to next level of performance. The IP stage shows three processes at level ‘c’ and one at level ‘d’. Thus, processes related to idea selection, IP administration, and IP inventory (non-commercialized IP) are at the mid-level, and there is scope to improve the IP assessment-related system so that it can move from level ‘d’ to next higher level of performance. The post-IP stage consists of two processes at performance level ‘d’ and one process at performance level ‘c’. Thus, IP commercialization is at the mid-level and there is a need to improve IP maintenance and IP inventory (commercialized IP) related processes. The organization's IP acquisition and IP enforcement performance is at level ‘d’ and ‘e’ respectively. At this stage, the organization needs to strengthen the first three stages (pre IP, IP, and post IP) to create an idea inventory and an IP inventory (commercialized and non-commercialized). A detailed computation of Organization ‘X’'s IPMPI is presented below:

| A. Pre-IP | B. IP | C. Post-IP | D. IP | E. IP |
|---|---|---|---|---|
| stage: | stage: | stage | acquisition | enforcement |
| c | c | d | d | e |
| c | c | c | d | |
| d | d | d | | |
| d | c | | | |
| d | | | | |

Calculation of IPMPI for Organization ‘X’:

A[1(c)+2(c)+3(d)+4(d)+5(d)]=p=12

B[1(c)+2(c)+3(d)+4(c)]=q=11

C[1(d)+2(c)+3(d)]=r=7

D[1(d)+2(d)]=s=4

E[1(e)]=t=1

Therefore, IPM Performance Index (IPMPI) for Organization ‘X’=p+q+r+s+t=35

### Organization ‘Y’:

| A. Pre-IP | B. IP | C. Post-IP | D. IP | E. IP |
|---|---|---|---|---|
| stage | stage | stage | acquisition | enforcement |
| b | b | b | b | c |
| b | b | b | b | |
| b | b | b | | |
| c | b | | | |
| b | | | | |

### Calculation of IPMPI for Organization ‘Y’:

A[1(b)+2(b)+3(b)+4(b)+5(b)]=p=20

B[1(b)+2(b)+3(b)+4(c)]=q=15

C[1(b)+2(b)+3(b)]=r=12

D[1(b)+2(b)]=s=8

E[1(c)]=t=3

Therefore, IPM Performance Index (IPMPI) for Organization ‘Y’=p+q+r+s+t=58

### Organization ‘Z’:

| A. Pre-IP | B. IP | C. Post-IP | D. IP | E. IP |
|---|---|---|---|---|
| stage: | stage: | stage | acquisition | enforcement |
| e | d | d | e | e |
| d | d | d | e | |
| d | d | e | | |
| d | e | | | |
| d | | | | |

### Calculation of IPMPI for Organization ‘Z’:

A[1(e)+2(d)+3(d)+4(d)+5(d)]=p=9

B[1(d)+2(d)+3(d)+4(e)]=q=7

C[1(d)+2(d)+3(e)]=r=5

D[1(e)+2(e)]=s=2

E[1(e)]=t=1

Therefore, IPM Performance Index (IPMPI) for Organization ‘Z’=p+q+r+s+t=24

By using IPMS of the present invention comprising ‘IPM audit tool’, IPMPI is computed for the organizations and then these are mapped on ‘IPM maturity model’. Organization ‘X’ scored IPMPI 35 and classifies under ‘profit center level’ of IPM maturity, Organization ‘Y’ scored IPMPI 58 and classifies under ‘integrative level’ of IPM maturity and organization ‘Z’ with IPMPI 24 classifies in ‘cost center level’ on ‘IPM maturity model’. It is experienced that use of ‘IPM audit tool’, for classifying organizations on the ‘IPM maturity model’ to understand the IPM performance maturity of an organization was comparatively easy task. Mapping of the organization on the IPMS design matrix is shown in FIG. 6.

Although the invention has been described with reference to particular examples of the invention, it should be appreciated that it may be exemplified in other forms. The invention qualifies to be adopted in a variety of other embodiments such modifications and alternatives obtaining the advantages and the benefits of the present invention will be apparent to those skilled in the art. Further the present invention has been described with respect to certain specific embodiments, it will be clear to those skilled in the art that the inventive features of the present invention are applicable to other embodiments as well, all of which are intended to fall within the scope of the present invention.

The description herein contains many specifics; these should not be construed as limiting the scope of the invention, but as merely providing illustrations of some of the embodiments of the invention. One of ordinary skill in the art will appreciate that elements and materials other than those specifically exemplified can be employed in the practice of the invention without resort to undue experimentation. All art-known functional equivalents, of any such elements and materials are intended to be included in this invention. Numerous variations, changes and substitutions may be made without departing from the invention herein.

I claim:

1. A network-based system to estimate Intellectual Property Management (IPM) maturity level of an organization and generate a report/analytics for Intellectual Property Management (IPM), comprising:
at least one server connected to the communications network and comprising a processor;
at least one centralized database connected to the communications network to store the intellectual property and related information;
at least one user input device comprising a processor to access the server in a limited manner over the communications network to update the intellectual property and related information associated with organization or like to store in the centralized database;
at least one access portal for Intellectual property management; and
at least one calculation unit estimating the Intellectual Property Management Performance Index (IPMPI);
wherein the access portal comprising Intellectual Property Management audit tool classifies the intellectual property information associated with organization, stored in the centralized database via the server;
wherein the classification is based on plurality of predefined stage parameters comprising plurality of predefined key Intellectual Property Management (IPM) process parameter(s) defining Intellectual Property (IP) management audit model; and
wherein each said predefined key Intellectual Property Management (IPM) process parameter comprises plurality of predefined level parameters to input into said calculation unit to project the performance level of the organization based on said predefined key Intellectual Property Management (IPM) process parameters and the Intellectual Property Management Performance Index (IPMPI).

2. The system as claimed in claim 1, wherein said predefined key Intellectual Property Management (IPM) process parameters are comprised of 15 IPM process parameters, grouping IPM process parameters followed at organization, organized into said 5 predefined stage parameters such that each said stage parameter generates intellectual property inventory.

3. The system as claimed in claims 1 to 2, wherein
a. the first stage parameter is grouped based on Intellectual Property generation identifying potential Intellectual Property comprising five said IPM process parameters to produce idea inventory.
b. the second stage parameter is grouped based on Intellectual Property protection where Intellectual Property is protected and is ready for commercial and/or strategic exploitation comprising four IPM process parameters to produce non-commercialized Intellectual Property inventory.
c. the third stage parameter is grouped based on commercialized Intellectual Property identifying commercial or strategic important Intellectual Property comprising three IPM process parameters to produce commercialized Intellectual Property inventory.
d. the fourth stage parameter is grouped based on strategic intervention identifying valuation of the Intellectual Property to be acquired and forecasting the post acquisition consequences comprising two IPM process parameters to produce acquired Intellectual Property inventory.
e. the fifth stage parameter is grouped based on monitoring and implementing Intellectual Property enforcement related activities comprising one IPM process parameter.

4. The system as claimed in claim 1 to 3, wherein said predefined level parameters are comprised of 5 level parameters in each said IPM process parameter, wherein each said level is assigned a predefined value.

5. The system as claimed in claims 1 to 4, wherein said Intellectual Property Management Performance Index (IPMPI) is cumulative score estimated by the said stage parameters comprising key IPM process parameters with said assigned level value.

6. The system as claimed in claims 1 to 5, wherein said Intellectual Property Management (IPM) maturity level of an organization is based on mapping of said Intellectual Property Management Performance Index (IPMPI) in a predefined Intellectual Property Management (IPM) maturity model depending on the cumulative score of the IPMPI.

7. The system as claimed in claims 1 to 6, wherein the said calculation unit projects the performance level of the organization by IPMS design matrix based on said an IPM maturity model.

8. A system to estimate Intellectual Property Management (IPM) maturity level of an organization and generate a report/analytics for Intellectual Property Management (IPM), comprising:
at least one memory unit to store the Intellectual Property information;
at least one user interface with a processor to input and analyze Intellectual Property information; and
at least one calculation unit estimating the Intellectual Property Management Performance Index (IPMPI);
wherein the system comprising Intellectual Property Management audit tool classifies the intellectual property information associated with organization, stored in the memory unit;
wherein the classification is based on plurality of predefined stage parameters comprising plurality of predefined key Intellectual Property Management (IPM) process parameter(s) defining Intellectual Property (IP) management audit model; and
wherein each said predefined key Intellectual Property Management (IPM) process parameter comprises plurality of predefined levels to input into said calculation unit to project the performance level of the organization based on said predefined key Intellectual Property Management (IPM) process parameters and the Intellectual Property Management Performance Index (IPMPI).

9. The system as claimed in claim 8, wherein said predefined key Intellectual Property Management (IPM) process parameters are comprised of 15 IPM process parameters organized into said 5 predefined stage parameters, grouping IPM process parameters followed at organization, such that each said stage parameter generates intellectual property inventory.

10. The system as claimed in claims 8 and 9,
a. wherein the first stage parameter is grouped based on Intellectual Property generation identifying potential Intellectual Property comprising five said IPM process parameters to produce idea inventory.
b. wherein the second stage parameter is grouped based on Intellectual Property protection where Intellectual Property is protected and is ready for commercial and/or strategic exploitation comprising four IPM process parameters to produce non-commercialized Intellectual Property inventory.
c. wherein the third stage parameter is grouped based on commercialized Intellectual Property identifying commercial or strategic important Intellectual Property comprising three IPM process parameters to produce commercialized Intellectual Property inventory.
d. wherein the fourth stage parameter is grouped based on strategic intervention identifying valuation of the Intellectual Property to be acquired and forecasting the post acquisition consequences comprising two IPM process parameters to produce acquired Intellectual Property inventory.
e. wherein the fifth stage parameter is grouped based on monitoring and implementing Intellectual Property enforcement related activities comprising one IPM process parameter.

11. The system as claimed in claims 8 to 10, wherein said predefined level parameters are comprised of 5 level parameters in each said IPM process parameter, wherein each said level is assigned a predefined value.

12. The system as claimed in claims 8 to 11, wherein said Intellectual Property Management Performance Index (IPMPI) is cumulative score estimated by the said stage parameters comprising key IPM process parameters with said assigned level value.

13. The system as claimed in claims 8 to 12, wherein said Intellectual Property Management (IPM) maturity level of an organization is based on mapping of said Intellectual Property Management Performance Index (IPMPI) in a predefined Intellectual Property Management (IPM) maturity model depending on the cumulative score of the IPMPI.

14. The system as claimed in claims 8 to 13, wherein the said calculation unit projects the performance level of the organization by a design matrix based on said an IPM maturity model.

15. The system as claimed in claims 1 to 14, wherein said IPM maturity model, IPMPI computation, IPMS design matrix and IPM audit tool can be organized, customized, extrapolated or such a relevant modifications can be anticipated to design various matrices, models and tools suitable for particular activity related to Intellectual Property management at individual, organizational, industrial, sector, country level.
